(19) United States
(12) Patent Application Publication
(10) Pub. No.: US 2013/0306463 A1
(43) Pub. Date: Nov. 21, 2013

(54) PURIFYING A FLUID USING A HEAT CARRIER COMPRISING AN ELECTROMAGNETIC RADIATION-ABSORBING COMPLEX

(71) Applicants: Nancy J. Halas, Houston, TX (US); Peter Nordlander, Houston, TX (US); Oara Neumann, Houston, TX (US)

(72) Inventors: Nancy J. Halas, Houston, TX (US); Peter Nordlander, Houston, TX (US); Oara Neumann, Houston, TX (US)

(73) Assignee: WILLIAM MARSH RICE UNIVERSITY, Houston, TX (US)

(21) Appl. No.: 13/992,898

(22) PCT Filed: Nov. 30, 2011
(86) PCT No.: PCT/US2011/062507

§ 371 Date: Aug. 12, 2013

Related U.S. Application Data
(60) Provisional application No. 61/423,299, filed on Dec. 15, 2010.

(51) Int. Cl. B01D 3/34

(52) U.S. Cl. CPC B01D 3/34
USPC 203/50; 202/185.1

(57) ABSTRACT

In general, the invention relates to a system. The system includes a heating fluid vessel (1604) that includes first fluid and a complex, where the complex receives electromagnetic (EM) radiation (1602), and where the complex absorbs the EM radiation to generate heat and where the heat increases a temperature of the first fluid to generate a first heated fluid (1606). The system further includes a heat exchanger (1608) adapted to receive the first heated fluid (1606) and complex in a first chamber, receive a mixture including a second fluid in a second chamber, and transfer the heat from the first fluid from the complex to the mixture to transform at least a portion of the target fluid of the mixture to a target vapor. The system further includes a condenser (1632) adapted to receive the target vapor, and condense the target vapor to generate target fluid (1636).

### CROSS REFERENCE TO RELATED APPLICATIONS

This application claims priority under 35 U.S.C. §119(e) to U.S. Provisional Patent Application Ser. No. 61/423,299, which is incorporated by reference in its entirety.

### STATEMENT REGARDING FEDERALLY SPONSORED RESEARCH OR DEVELOPMENT

The present invention was made with government support under Grant Number DE-AC52-06NA25396 awarded by the Department of Energy. The government has certain rights in the invention.

### BACKGROUND

The process of purifying a fluid involves removing impurities, compounds, and other elements from a fluid in a raw state to end with a purified fluid. Removing unwanted elements of the fluid may involve one or more types of separation process, including but not limited to filtration, use of centrifugal force, and distillation. Distillation involves heating the liquid to a temperature that allows the fluid to be purified to evaporate while some or all of the unwanted elements remain in liquid form or, alternatively, allows the fluid to be purified to remain in liquid form while some or all of the unwanted elements evaporate.

### SUMMARY

In general, in one aspect, the invention relates to a method to purify a fluid, the method comprising sending a first fluid comprising a complex through a heating fluid vessel, applying, while the first fluid is in the heating fluid vessel, electromagnetic (EM) radiation to the complex, wherein the complex absorbs the EM radiation to generate heat and wherein the heat increases a temperature of the first fluid to generate a first heated fluid, sending the first heated fluid through a first chamber of a heat exchanger, sending, while the first heated fluid flows through the first chamber of the heat exchanger, a mixture into a second chamber of the heat exchanger, wherein the mixture comprises a second fluid, transforming, using the heat generated by the complex in the first heated fluid, at least a portion of the second fluid of the mixture to a target vapor, sending the target vapor from the second chamber of the heat exchanger to a condenser, condensing, in the condenser, the target vapor to obtain a purified fluid, and extracting the purified fluid from the condenser, vessel, where the complex is at least one selected from a group consisting of copper nanoparticles, copper oxide nanoparticles, nanoshells, nanorods, carbon moieties, encapsulated nanoshells, encapsulated nanoparticles, and branched nanostructures.

In general, in one aspect, the invention relates to a system, comprising a heating fluid vessel abutting the heating tank, wherein the heating fluid vessel comprises a complex and is configured to apply electromagnetic (EM) radiation to the complex, wherein the complex absorbs the EM radiation to generate heat, provide the heat generated by the complex to the heating tank, and the heating tank adapted to receive a mixture comprising the target fluid from a target fluid source, and receive the heat generated by the complex from the heating fluid vessel, wherein the heat received by the heating tank transforms at least the target fluid of the mixture to a target vapor, and a condenser adapted to receive the target fluid from the heating tank, and condense the target vapor to generate target fluid.

In general, in one aspect, the invention relates to a heating vessel, comprising a complex and adapted to receive a mixture comprising the target fluid from a target fluid source, concentrate electromagnetic (EM) radiation received from an EM radiation source to obtained concentrated EM radiation, and apply the concentrated EM radiation to the complex, wherein the complex absorbs the concentrated EM radiation to generate heat, wherein the heat generated by the complex transforms at least the target fluid of the mixture to a target vapor, and wherein the target vapor is removed from the heating vessel and condensed to a target fluid.

### BRIEF DESCRIPTION OF DRAWINGS

FIG. 1 shows a schematic of a complex in accordance with one or more embodiments of the invention.

FIG. 2 shows a flow chart in accordance with one or more embodiments of the invention.

FIG. 3 shows a chart of the absorbance in accordance with one or more embodiments of the invention.

FIGS. 4A-4B show charts of an energy dispersive x-ray spectroscopy (EDS) measurement in accordance with one or more embodiments of the invention.

FIG. 5 shows a chart of the absorbance in accordance with one or more embodiments of the invention.

FIG. 6 shows a chart of an EDS measurement in accordance with one or more embodiments of the invention.

FIG. 7 shows a chart of the absorbance in accordance with one or more embodiments of the invention.

FIG. 8 shows a flow chart in accordance with one or more embodiments of the invention.

FIG. 9 shows a chart of the absorbance in accordance with one or more embodiments of the invention.

FIG. 10 shows a chart of an EDS measurement in accordance with one or more embodiments of the invention.

FIGS. 11A-11C show charts of the porosity of gold corral structures in accordance with one or more embodiments of the invention.

FIGS. 12A-12C show charts of the mass loss of water into steam in accordance with one or more embodiments of the invention.

FIGS. 13A-13B show charts of the energy capture efficiency in accordance with one or more embodiments of the invention.

FIG. 14 shows a system in accordance with one or more embodiments of the invention.

FIG. 15 shows a flowchart for a method of purifying a fluid in accordance with one or more embodiments of the invention.

FIG. 16 shows a single line diagram of an example system for purifying a fluid in accordance with one or more embodiments of the invention.

FIGS. 17A and 17B show examples of a vessel including a complex and a fluid in accordance with one or more embodiments of the invention.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

In general, embodiments of the invention provide for purifying a fluid using an electromagnetic (EM) radiation-absorbing complex. More specifically, one or more embodiments of the invention provide for separating a target fluid from a mixture by creating a vapor (e.g., steam) of the target fluid (e.g., water) from a mixture by heating the mixture using one or more complexes (e.g., nanoshells) that have absorbed EM radiation. The mixture may be a fluid, with or without some amount of solid (e.g., dirt). The invention may provide for a complex mixed in a liquid solution, used to coat a wall of a vessel, integrated with a material of which a vessel is made, and/or otherwise suitably integrated with a vessel used to apply EM radiation to the complex. All the piping and associated fittings, pumps, valves, gauges, and other equipment described, used, or contemplated herein, either actually or as one of ordinary skill in the art would conceive, are made of materials resistant to the heat and/or fluid and/or vapor transported, transformed, pressurized, created, or otherwise handled within those materials.

A source of EM radiation may be any source capable of emitting energy at one or more wavelengths. For example, EM radiation may be any source that emits radiation in the ultraviolet, visible, and infrared regions of the electromagnetic spectrum. A source of EM radiation may be manmade or occur naturally. Examples of a source of EM radiation may include, but are not limited to, the sun, waste heat from an industrial process, and a light bulb. One or more concentrators may be used to intensify and/or concentrate the energy emitted by a source of EM radiation. Examples of a concentrator include, but are not limited to, lens(es), a parabolic trough(s), mirror(s), black paint, or any combination thereof.

Embodiments of this invention may be used in any residential, commercial, and/or industrial application where purification of a fluid may be required. Examples of such applications include, but are not limited to, municipal services, chemical treatment, processing and manufacturing for a number of market sectors (e.g., food processing and packaging, pulp and paper, printing, chemicals and allied products, rubber, plastics, cosmetics, textile production, electronics), hospitals, universities, laboratories, drug manufacturing, wastewater and sewage treatment, and beverages.

In one or more embodiments, the complex may include one or more nanoparticle structures including, but not limited to, nanoshells, coated nanoshells, metal colloids, nanorods, branched or coral structures, and/or carbon moieties. In one or more embodiments, the complex may include a mixture of nanoparticle structures to absorb EM radiation. Specifically, the complex may be designed to maximize the absorption of the electromagnetic radiation emitted from the sun. Further, each complex may absorb EM radiation over a specific range of wavelengths.

In one or more embodiments, the complex may include metal nanoshells. A nanoshell is a substantially spherical dielectric core surrounded by a thin metallic shell. The plasmon resonance of a nanoshell may be determined by the size of the core relative to the thickness of the metallic shell. Nanoshells may be fabricated according to U.S. Pat. No. 6,685,986, hereby incorporated by reference in its entirety. The relative size of the dielectric core and metallic shell, as well as the optical properties of the core, shell, and medium, determines the plasmon resonance of a nanoshell. Accordingly, the overall size of the nanoshell is dependent on the absorption wavelength desired. Metal nanoshells may be designed to absorb or scatter light throughout the visible and infrared regions of the electromagnetic spectrum. For example, a plasmon resonance in the near infrared region of the spectrum (700 nm-900 nm) may have a substantially spherical silica core having a diameter between 90 nm-175 nm and a gold metallic layer between 4 nm-35 nm.

A complex may also include other core-shell structures, for example, a metallic core with one or more dielectric and/or metallic layers using the same or different metals. For example, a complex may include a gold or silver nanoparticle, spherical or rod-like, coated with a dielectric layer and further coated with another gold or silver layer. A complex may also include other core-shell structures, for example hollow metallic shell nanoparticles and/or multi-layer shells.

In one or more embodiments, a complex may include a nanoshell encapsulated with a dielectric or rare earth element oxide. For example, gold nanoshells may be coated with an additional shell layer made from silica, titanium or europium oxide.

In one embodiment of the invention, the complexes may be aggregated or otherwise combined to create aggregates. In such cases, the resulting aggregates may include complexes of the same type or complexes of different types.

In one embodiment of the invention, complexes of different types may be combined as aggregates, in solution, or embedded on substrate. By combining various types of complexes, a broad range of the EM spectrum may be absorbed.

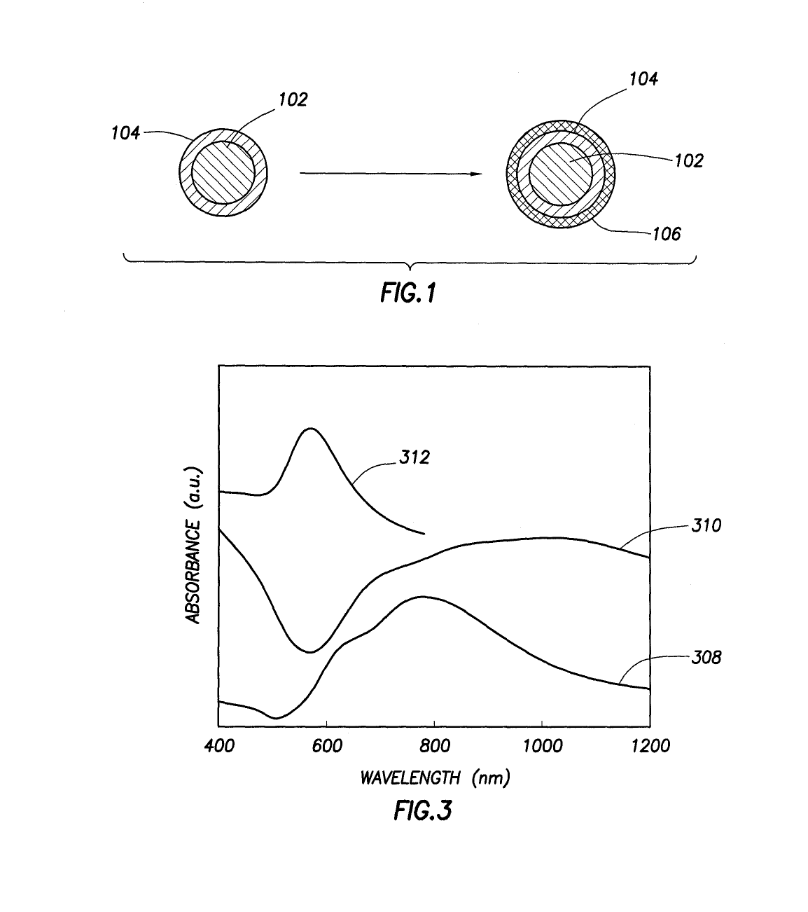

FIG. 1 is a schematic of a nanoshell coated with an additional rare earth element oxide in accordance with one or more embodiments of the invention. Typically, a gold nanoshell has a silica core 102 surrounded by a thin gold layer 104. As stated previously, the size of the gold layer is relative to the size of the core and determines the plasmon resonance of the particle. According to one or more embodiments of the invention, a nanoshell may then be coated with a dielectric or rare earth layer 106. The additional layer 106 may serve to preserve the resultant plasmon resonance and protect the particle from any temperature effects, for example, melting of the gold layer 104.

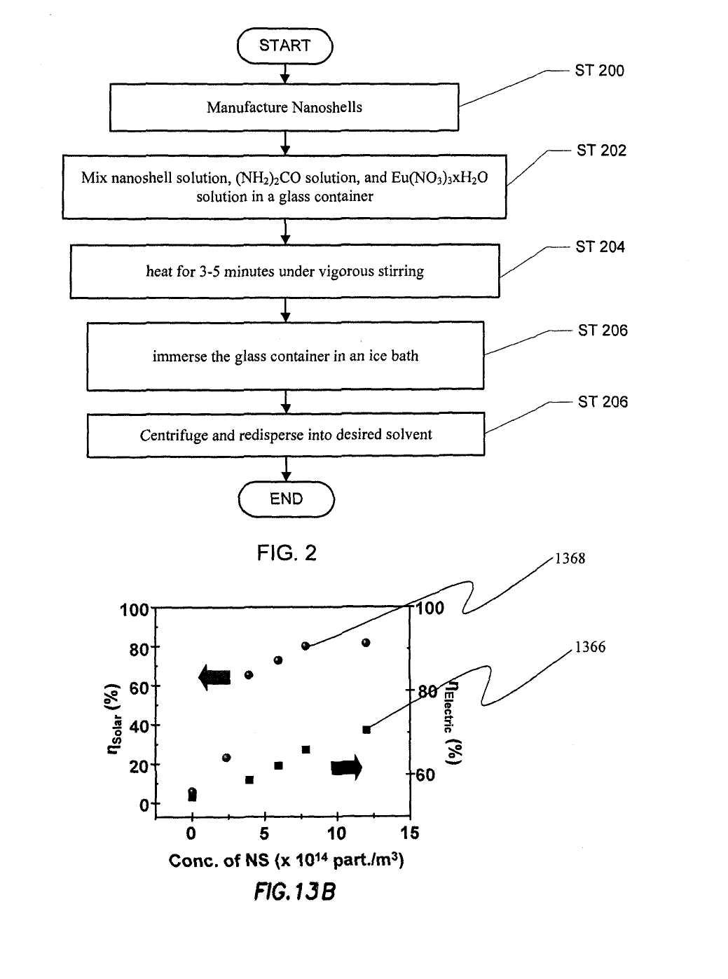

FIG. 2 is a flow chart of a method of manufacturing the coated nanoshells in accordance with one or more embodiments of the invention. In ST 200, nanoshells are manufactured according to known techniques. In the example of europium oxide, in ST 202, 20 mL of a nanoshell solution may be mixed with 10 mL of 2.5M (NH₂)₂CO and 20 mL of 0.1M of Eu(NO₃)₃xH₂O solutions in a glass container. In ST 204, the mixture may be heated to boiling for 3-5 minutes under vigorous stirring. The time the mixture is heated may determine the thickness of the additional layer, and may also determine the number of nanoparticle aggregates in solution. The formation of nanostructure aggregates is known to create additional plasmon resonances at wavelengths higher than the individual nanostructure that may contribute to the energy absorbed by the nanostructure for heat generation. In ST 206, the reaction may then be stopped by immersing the glass container in an ice bath. In ST 208, the solution may then be cleaned by centrifugation, and then redispersed into the desired solvent. The additional layer may contribute to the solubility of the nanoparticles in different solvents. Solvents that may be used in one or more embodiments of the invention include, but are not limited to, water, ammonia, ethylene glycol, and glycerin.

In addition to europium, other examples of element oxides that may be used in the above recipe include, but are not limited to, erbium, samarium, praseodymium, and dysprosium. The additional layer is not limited to rare earth oxides. Any coating of the particle that may result in a higher melting point, better solubility in a particular solvent, better deposition onto a particular substrate, and/or control over the number of aggregates or plasmon resonance of the particle may be used. Examples of the other coatings that may be used, but are not limited to silica, titanium dioxide, polymer-based coatings, additional layers formed by metals or metal alloys, and/or combinations of materials.

FIG. 3 is an absorbance spectrum of three nanoparticle structures that may be included in a complex in accordance with one or more embodiments disclosed herein. In FIG. 3, a gold nanoshell spectrum 308 may be engineered by selecting the core and shell dimensions to obtain a plasmon resonance peak at ˜800 nm. FIG. 3 also includes a Eu₂O₃-encapsulated gold nanoshell spectrum 310, where the Eu₂O₃-encapsulated gold nanoshell is manufactured using the same nanoshells from the nanoshell spectrum 308. As may be seen in FIG. 3, there may be some particle aggregation in the addition of the europium oxide layer. However, the degree of particle aggregation may be controlled by varying the reaction time described above. FIG. 3 also includes a ˜100 nm diameter spherical gold colloid spectrum 312 that may be used to absorb electromagnetic radiation in a different region of the electromagnetic spectrum. In the specific examples of FIG. 3, the Eu₂O₃-encapsulated gold nanoshells may be mixed with the gold colloids to construct a complex that absorbs any EM radiation from 500 nm to greater than 1200 nm. The concentrations of the different nanoparticle structures may be manipulated to achieve the desired absorption of the complex.

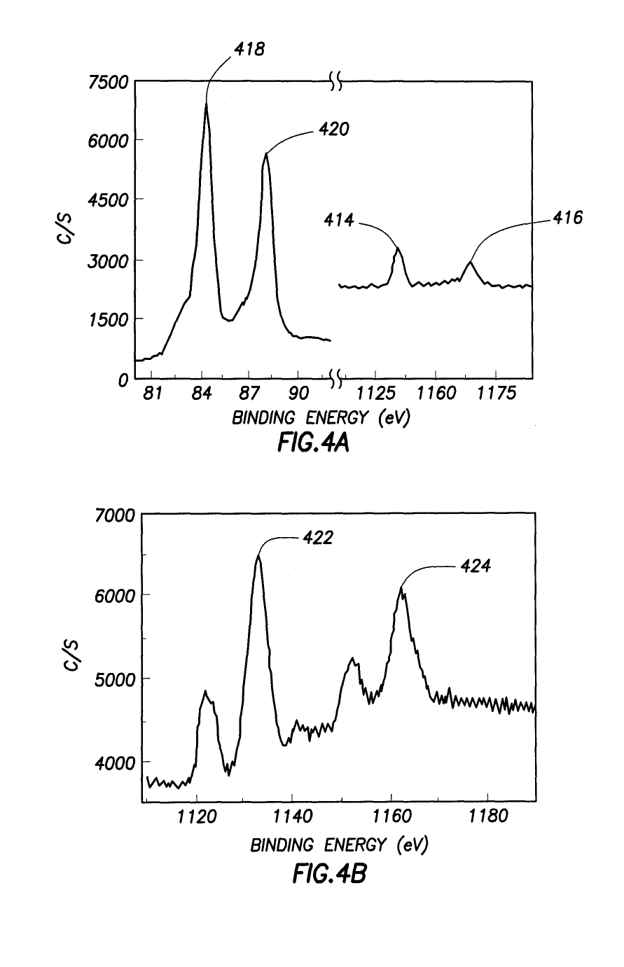

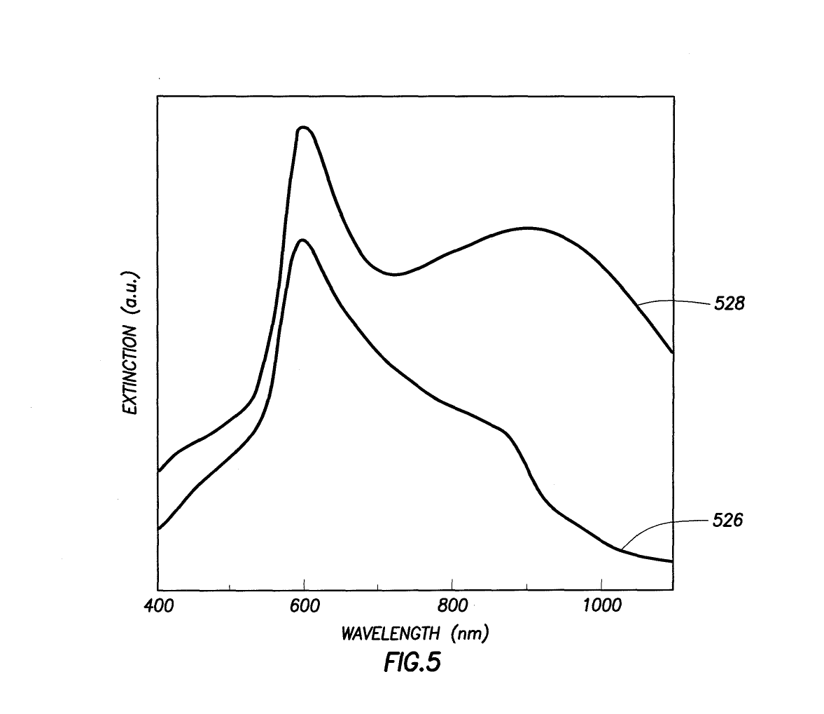

X-ray photoelectron spectroscopy (XPS) and/or energy dispersive x-ray spectroscopy (EDS) measurements may be used to investigate the chemical composition and purity of the nanoparticle structures in the complex. For example, FIG. 4A shows an XPS spectrum in accordance with one or more embodiments of the invention. XPS measurements were acquired with a PHI Quantera X-ray photoelectron spectrometer. FIG. 4A shows the XPS spectra in different spectral regions corresponding to the elements of the nanoshell encapsulated with europium oxide. FIG. 4A shows the XPS spectra display the binding energies for Eu (3d 5/2) at 1130 eV 414, Eu (2d 3/2) at 1160 eV 416, Au (4f 7/2) at 83.6 eV 418, and Au (4f 5/2) at 87.3 eV 420 of nanoshells encapsulated with europium oxide. For comparison, FIG. 4B shows an XPS spectrum of europium oxide colloids that may be manufactured according to methods known in the art. FIG. 4B shows the XPS spectra display the binding energies for Eu (3d 5/2) at 1130 eV 422 and Eu (2d 3/2) at 1160 eV 424 of europium oxide colloids.

In one or more embodiments of the invention, the complex may include solid metallic nanoparticles encapsulated with an additional layer as described above. For example, using the methods described above, solid metallic nanoparticles may be encapsulated using silica, titanium, europium, erbium, samarium, praseodymium, and dysprosium. Examples of solid metallic nanoparticles include, but are not limited to, spherical gold, silver, copper, or nickel nanoparticles or solid metallic nanorods. The specific metal may be chosen based on the plasmon resonance, or absorption, of the nanoparticle when encapsulated. The encapsulating elements may be chosen based on chemical compatibility, the encapsulating elements ability to increase the melting point of the encapsulated nanoparticle structure, and the collective plasmon resonance, or absorption, of a solution of the encapsulated nanostructure, or the plasmon resonance of the collection of encapsulated nanostructures when deposited on a substrate.

In one or more embodiments, the complex may also include copper colloids. Copper colloids may be synthesized using a solution-phase chemical reduction method. For example, 50 mL of 0.4 M aqueous solution of L-ascorbic acid, 0.8M of Polyvinyl pyridine (PVP), and 0.01M of copper (II) nitride may be mixed and heated to 70 degree Celsius until the solution color changes from a blue-green color to a red color. The color change indicates the formation of copper nanoparticles. FIG. 5 is an experimental and theoretical spectrum in accordance with one or more embodiments of the invention. FIG. 5 includes an experimental absorption spectrum 526 of copper colloids in accordance with one or more embodiments of the invention. Therefore, copper colloids may be used to absorb electromagnetic radiation in the 550 nm to 900 nm range.

FIG. 5 also includes a theoretical absorption spectrum 528 calculated using Mie scattering theory. In one or more embodiments, Mie scattering theory may be used to theoretically determine the absorbance of one or more nanoparticle structures to calculate and predict the overall absorbance of the complex. Thus, the complex may be designed to maximize the absorbance of solar electromagnetic radiation.

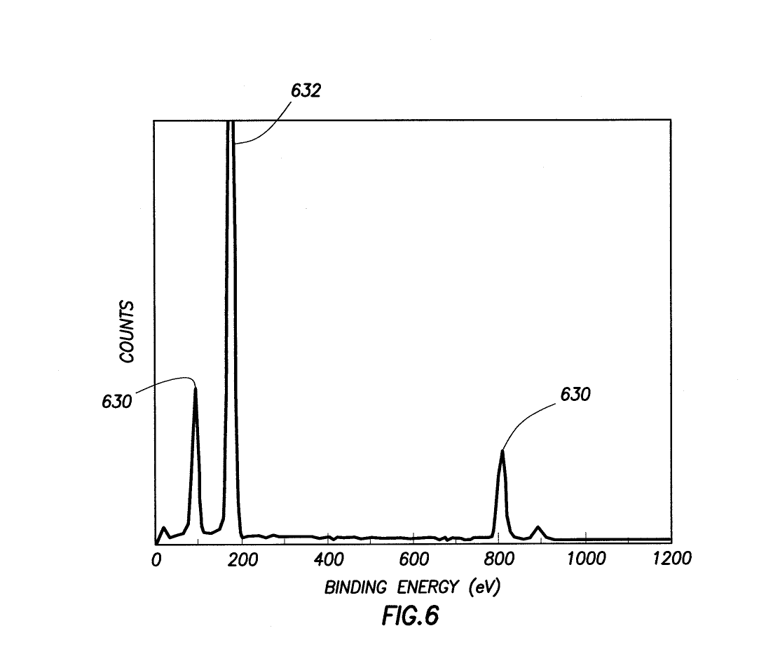

Referring to FIG. 6, an EDS spectrum of copper colloids in accordance with one or more embodiments of the invention is shown. The EDS spectrum of the copper colloids confirms the existence of copper atoms by the appearance peaks 630. During the EDS measurements, the particles are deposited on a silicon substrate, as evidenced by the presence of the silicon peak 632.

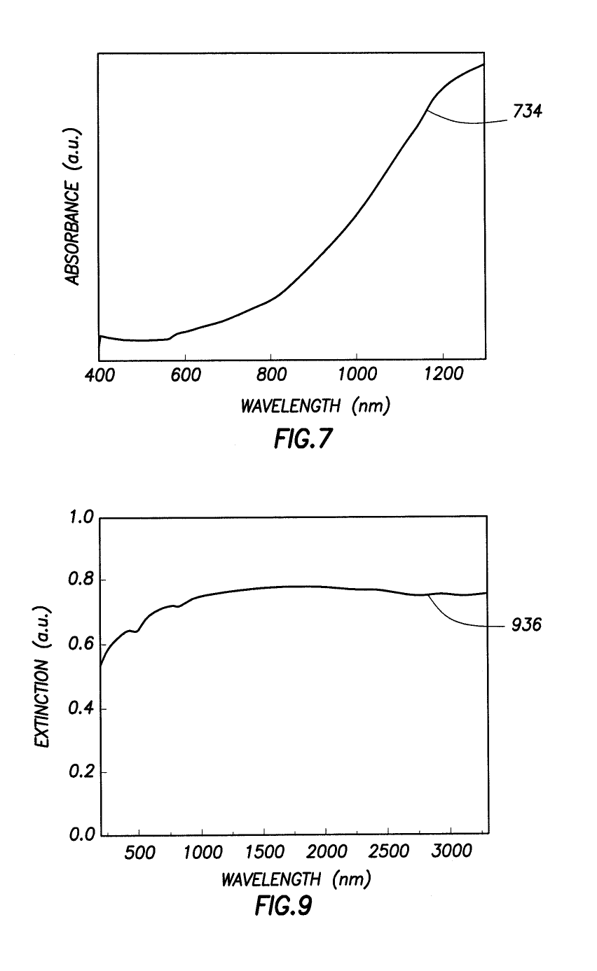

In one or more embodiments, the complex may include copper oxide nanoparticles. Copper oxide nanostructures may be synthesized by 20 mL aqueous solution of 62.5 mM Cu(NO₃)₂ being directly mixed with 12 mL NH₄OH under stirring. The mixture may be stirred vigorously at approximately 80° C. for 3 hours, then the temperature is reduced to 40° C. and the solution is stirred overnight. The solution color turns from blue to black color indicating the formation of a copper oxide nanostructure. The copper oxide nanostructures may then be washed and re-suspended in water via centrifugation. FIG. 7 shows the absorption of copper oxide nanoparticles in accordance with one or more embodiments of the invention. The absorption of the copper oxide nanoparticles 734 may be used to absorb electromagnetic radiation in the region from ˜900 nm to beyond 1200 nm.

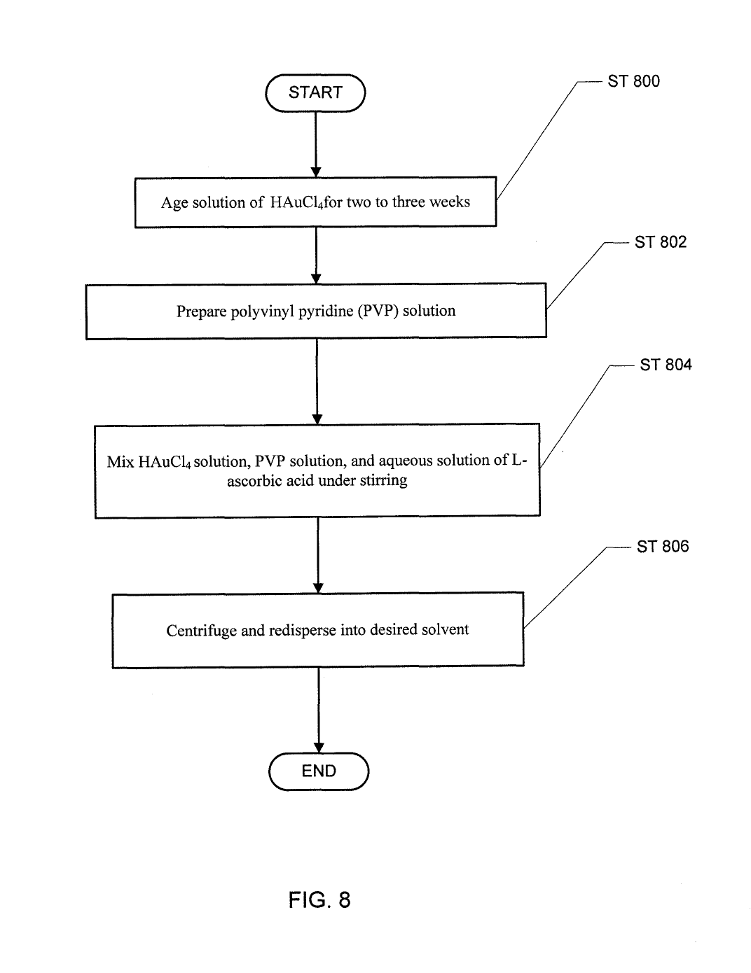

In one or more embodiments of the invention, the complex may include branched nanostructures. One of ordinary skill in the art will appreciate that embodiments of the invention are not limited to strict gold branched structures. For example, silver, nickel, copper, or platinum branched structures may also be used. FIG. 8 is a flow chart of the method of manufacturing gold branched structures in accordance with one or more embodiments of the invention. In ST 800, an aqueous solution of 1% HAuCl₄ may be aged for two-three weeks. In ST 802, a polyvinyl pyridine (PVP) solution may be prepared by dissolving 0.25 g in approximately 20 mL ethanol solution and resealed with water to a final volume of 50 mL. In ST 804, 50 mL of the 1% HAuCl₄ and 50 mL of the PVP solution may be directly mixed with 50 mL aqueous solution of 0.4M L-ascorbic acid under stirring. The solution color may turn immediately in dark blue-black color which indicates the formation of a gold nanoflower or nano-coral. Then, in ST 806, the Au nanostructures may then be washed and resuspended in water via centrifugation. In other words, the gold branched nanostructures may be synthesized through L-ascorbic acid reduction of aqueous chloroaurate ions at room temperature with addition of PVP as the capping agent. The capping polymer PVP may stabilize the gold branched nanostructures by preventing them from aggregating. In addition, the gold branched nanostructures may form a porous polymer-type matrix.

FIG. 9 shows the absorption of a solution of gold branched nanostructures in accordance with one or more embodiments of the invention. As can be seen in FIG. 9, the absorption spectrum 936 of the gold branched nanostructures is almost flat for a large spectral range, which may lead to considerably high photon absorption. The breadth of the spectrum 936 of the gold branched nanostructures may be due to the structural diversity of the gold branched nanostructures or, in other works, the collective effects of which may come as an average of individual branches of the gold branched/corals nanostructure.

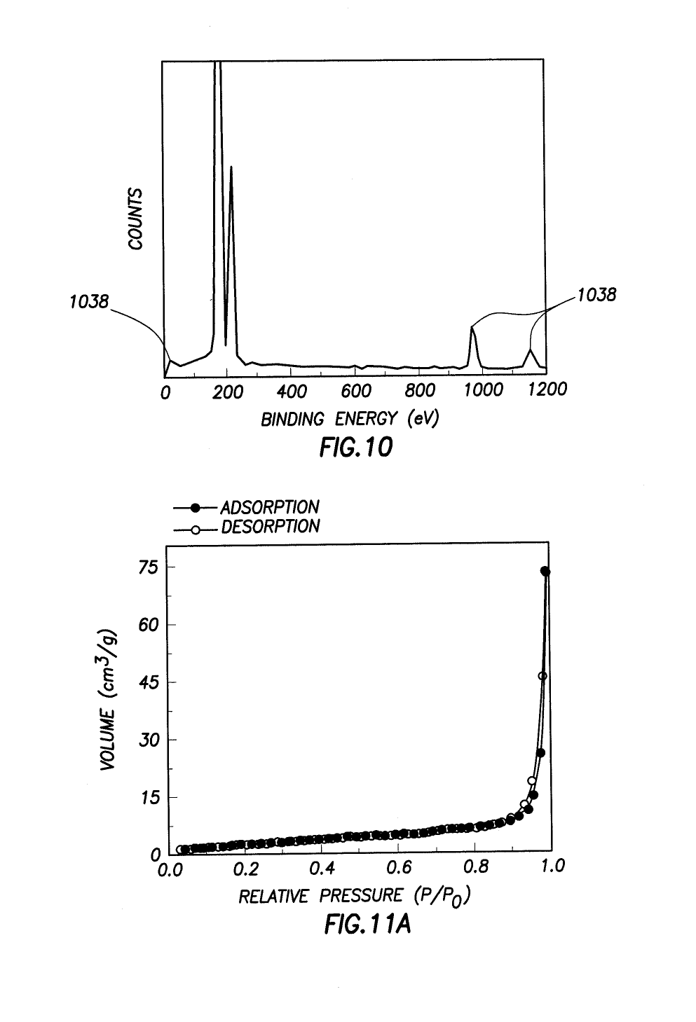

FIG. 10 shows the EDS measurements of the gold branched nanostructures in accordance with one or more embodiments of the invention. The EDS measurements may be performed to investigate the chemical composition and purity of the gold branched nanostructures. In addition, the peaks 1038 in the EDS measurements of gold branched nanostructures confirm the presence of Au atoms in the gold branched nanostructures.

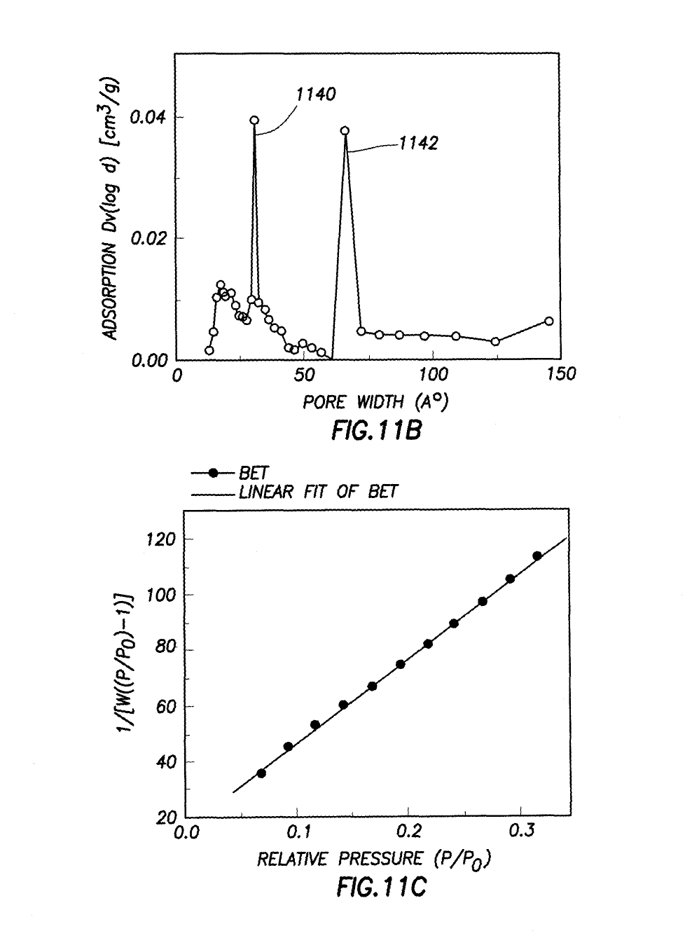

FIG. 11 shows a Brunauer-Emmett-Teller (BET) surface area and pore size distribution analysis of branches in accordance with one or more embodiments of the invention. The BET surface area and pore size may be performed to characterize the branched nanostructures. FIG. 11A presents the nitrogen adsorption-desorption isotherms of a gold corral sample calcinated at 150° C. for 8 hours. The isotherms may exhibit a type IV isotherm with a N₂ hysteresis loops in desorption branch as shown. As shown in FIG. 11A, the isotherms may be relatively flat in the low-pressure region (P/P₀<0.7). Also, the adsorption and desorption isotherms may be completely superposed, a fact which may demonstrate that the adsorption of the samples mostly likely occurs in the pores. At the relative high pressure region, the isotherms may form a loop due to the capillarity agglomeration phenomena. FIG. 11B presents a bimodal pore size distribution, showing the first peak 1140 at the pore diameter of 2.9 nm and the second peak 1142 at 6.5 nm. FIG. 11C shows the BET plots of gold branched nanostructures in accordance with one or more embodiments of the invention. A value of 10.84 m²/g was calculated for the specific surface area of branches in this example by using a multipoint BET-equation.

In one or more embodiments of the invention, the gold branched nanostructures dispersed in water may increase the nucleation sites for boiling, absorb electromagnetic energy, decrease the bubble lifetime due to high surface temperature and high porosity, and increase the interfacial turbulence by the water gradient temperature and the Brownian motion of the particles. The efficiency of a gold branched complex solution may be high because it may allow the entire fluid to be involved in the boiling process.

As demonstrated in the above figures and text, in accordance with one or more embodiments of the invention, the complex may include a number of different specific nanostructures chosen to maximize the absorption of the complex in a desired region of the electromagnetic spectrum. In addition, the complex may be suspended in different solvents, for example water or ethylene glycol. Also, the complex may be deposited onto a surface according to known techniques. For example, a molecular or polymer linker may be used to fix the complex to a surface, while allowing a solvent to be heated when exposed to the complex. The complex may also be embedded in a matrix or porous material. For example, the complex may be embedded in a polymer or porous matrix material formed to be inserted into a particular embodiment as described below. For example, the complex could be formed into a removable cartridge. As another example, a porous medium (e.g., fiberglass) may be embedded with the complex and placed in the interior of a vessel containing a fluid to be heated. The complex may also be formed into shapes in one or more embodiments described below in order to maximize the surface of the complex and, thus, maximize the absorption of EM radiation. In addition, the complex may be embedded in a packed column or coated onto rods inserted into one or more embodiments described below.

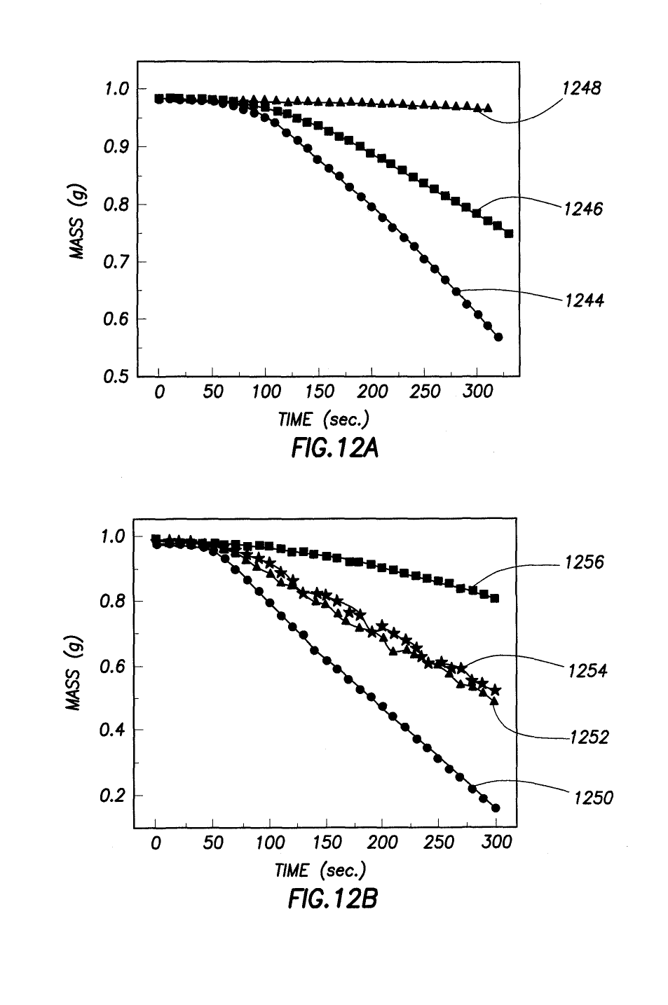

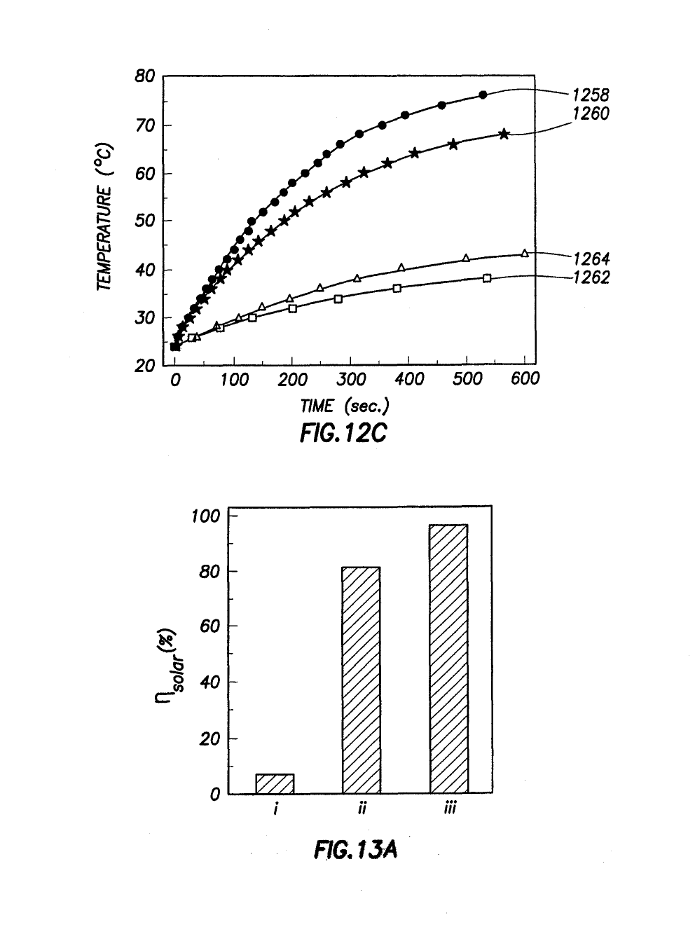

FIGS. 12A-12C show charts of the mass loss and temperature increase of different nanostructures that may be used in a complex in accordance with one or more embodiments of the invention. The results shown in FIGS. 12A-12C were performed to monitor the mass loss of an aqueous nanostructure solution for 10 minutes under sunlight (FIG. 12B) versus non-pulsed diode laser illumination at 808 nm (FIG. 12A). In FIG. 12A, the mass loss versus time of the laser illumination at 808 nm is shown for Eu₂O₃-coated nanoshells 1244, non-coated gold nanoshells 1246, and gold nanoparticles with a diameter of ˜100 nm 1248. Under laser exposure, as may be expected from the absorbance shown in FIG. 3, at 808 nm illumination, the coated and non-coated nanoshells exhibit a mass loss due to the absorbance of the incident electromagnetic radiation at 808 nm. In addition, as the absorbance is lower at 808 nm, the 100 nm diameter gold colloid exhibits little mass loss at 808 nm illumination. In FIG. 12A, the Au nanoparticles demonstrated a lower loss rate that was nearly the same as water because the laser wavelength was detuned from plasmon resonance frequency. The greatest mass loss was obtained by adding a layer around the gold nanoshells, where the particle absorption spectrum was approximately the same as the solar spectrum (see FIG. 3.)

In FIG. 12B, the mass loss as a function of time under exposure to the sun in accordance with one or more embodiments of the invention is shown. In FIG. 12B, the mass loss under sun exposure with an average power of 20 W is shown for Eu₂O₃-coated nanoshells 1250, non-coated gold nanoshells 1252, gold nanoparticles with a diameter of ˜100 nm 1254, and a water control 1256. As in the previous example, the greatest mass loss may be obtained by adding a rare earth or dielectric layer around a nanoshell.

The resulting mass loss curves in FIGS. 12A and 12B show significant water evaporation rates for Eu₂O₃-coated gold nanoshells. The mass loss may be slightly greater under solar radiation because the particles were able to absorb light from a broader range of wavelengths. In addition, the collective effect of aggregates broadens the absorption spectrum of the oxide-coated nanoparticles, which may help to further amplify the heating effect and create local areas of high temperature, or local hot spots. Aggregates may also allow a significant increase in boiling rates due to collective self organizing forces. The oxide layer may further enhance steam generation by increasing the surface area of the nanoparticle, thus providing more boiling nucleation sites per particle, while conserving the light-absorbing properties of the nanostructure.

FIG. 12C shows the temperature increase versus time under the 808 nm laser exposure in accordance with one or more embodiments of the invention. In FIG. 12C, the temperature increase under the 808 nm laser exposure is shown for Eu₂O₃-coated nanoshells 1258, non-coated gold nanoshells 1260, gold nanoparticles with a diameter of ˜100 nm 1262, and a water control 1264. As may be expected, the temperature of the solutions of the different nanostructures that may be included in the complex increases due to the absorption of the incident electromagnetic radiation of the specific nanostructure and the conversion of the absorbed electromagnetic radiation in to heat.

FIG. 13A is a chart of the solar trapping efficiency in accordance with one or more embodiments of the invention. To quantify the energy trapping efficiency of the complex, steam is generated in a flask and throttled through a symmetric convergent-divergent nozzle. The steam is then cooled and collected into an ice bath maintained at 0° C. The nozzle serves to isolate the high pressure in the boiler from the low pressure in the ice bath and may stabilize the steam flow. Accordingly, the steam is allowed to maintain a steady dynamic state for data acquisition purposes. In FIG. 13A, the solar energy capture efficiency (η) of water (i) and Eu2O3-coated nanoshells (ii) and gold branched (ii) nanostructures is shown. The resulting thermal efficiency of steam formation may be estimated at 80% for the coated nanoshell complex and 95% for a gold branched complex. By comparison, water has approximately 10% efficiency under the same conditions.

In one or more embodiments of the invention, the concentration of the complex may be modified to maximize the efficiency of the system. For example, in the case where the complex is in solution, the concentration of the different nanostructures that make up the complex for absorbing EM radiation may be modified to optimize the absorption and, thus, optimize the overall efficiency of the system. In the case where the complex is deposited on a surface, the surface coverage may be modified accordingly.

In FIG. 13B, the steam generation efficiency versus gold nanoshell concentration for solar and electrical heating in accordance with one or more embodiments of the invention is shown. The results show an enhancement in efficiency for both electrical 1366 and solar 1368 heating sources, confirming that the bubble nucleation rate increases with the concentration of complex. At high concentrations, the complex is likely to form small aggregates with small inter-structure gaps. These gaps may create “hot spots”, where the intensity of the electric field may be greatly enhanced, causing an increase in temperature of the surrounding water. The absorption enhancement under electrical energy 1366 is not as dramatic as that under solar power 1368 because the solar spectrum includes energetic photons in the NIR, visible and UV that are not present in the electric heater spectrum. At the higher concentrations, the steam generation efficiency begins to stabilize, indicating a saturation behavior. This may result from a shielding effect by the particles at the outermost regions of the flask, which may serve as a virtual blackbody around the particles in the bulk solution.

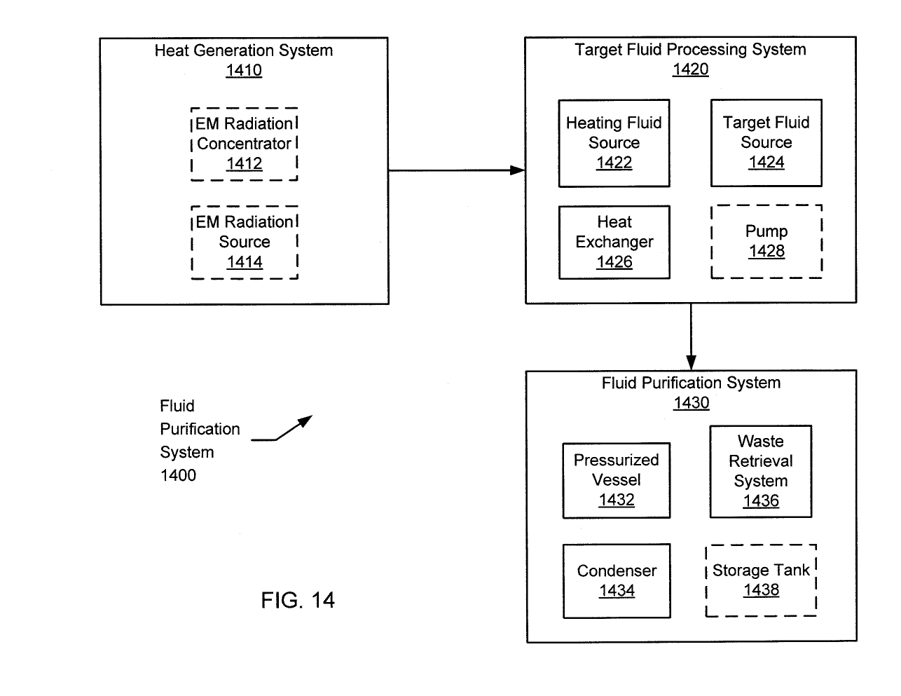

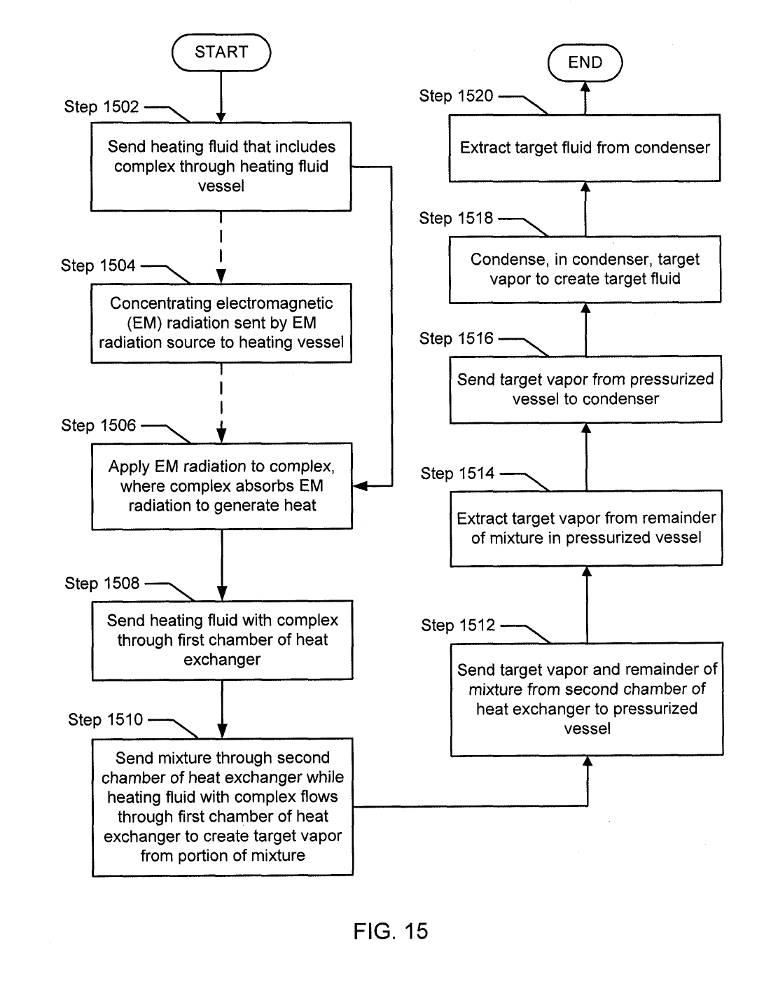

FIG. 14 shows a fluid purification system 1400 using a complex in accordance with one or more embodiments of the invention. The fluid purification system 1400 includes a heat generation system 1410, a target fluid processing system 1420, and a fluid purification system 1430. The heat generation system 1410 includes, optionally, an EM radiation source 1414 and an EM radiation concentrator 1412. The target fluid processing system 1420 includes a fluid heating source 1422, a target fluid source 1424, a heat exchanger 1426, and, optionally, a pump 1428. The fluid purification system 1430 includes a pressurized vessel 1432, a condenser 1434, a waste retrieval system 1436, and, optionally, a storage tank 1438. Each of these components is described with respect FIG. 14 below. One of ordinary skill in the art will appreciate that embodiments of the invention are not limited to the configuration shown in FIG. 14.

For each component shown in FIG. 14, as well as any other component implied and/or described but not shown in FIG. 14, may be configured to receive material from one component (i.e., an upstream component) of the fluid purification system 1400 and send material (either the same as the material received or material that has been altered in some way (e.g., vapor to fluid)) to another component (i.e., a downstream component) of the fluid purification system 1400. In all cases, the material received from the upstream component may be delivered through a series of pipes, pumps, valves, and/or other devices to control factors associated with the material received such as the flow rate, temperature, and pressure of the material received as it enters the component. Further, the fluid and/or vapor may be delivered to the downstream component using a different series of pipes, pumps, valves, and/or other devices to control factors associated with the material sent such as the flow rate, temperature, and pressure of the material sent as it leaves the component.

In one or more embodiments of the invention, the heat generation system 1410 of the fluid purification system 1400 is configured to provide EM radiation. The heat generation system 1410 may be ambient light, as produced by the sun or one or more light bulbs in a room. Optionally, in one or more embodiments of the invention, the EM radiation source 1414 is any other source capable of emitting EM radiation having one or a range of wavelengths. The EM radiation source 1414 may be a stream of flue gas derived from a combustion process using a fossil fuel, including but not limited to coal, fuel oil, natural gas, gasoline, and propane. In one or more embodiments of the invention, the stream of flue gas is created during the production of heat and/or electric power using a boiler to heat water using one or more fossil fuels. The stream of flue gas may also be created during some other industrial process, including but not limited to chemical production, petroleum refining, and steel manufacturing. The stream of flue gas may be conditioned before being received by the heat generation system 1410. For example, a chemical may be added to the stream of flue gas, or the temperature of the stream of flue gas may be regulated in some way. Conditioning the stream of flue gas may be performed using a separate system designed for such a purpose.

In one or more embodiments of the invention, the EM radiation source 1414 is any other natural and/or manmade source capable of emitting one or more wavelengths of energy. The EM radiation source 1414 may also be a suitable combination of sources of EM radiation, whether emitting energy using the same wavelengths or different wavelengths.

Optionally, in one or more embodiments of the invention, the EM radiation concentrator 1412 is a device used to intensify the energy emitted by the EM radiation source 1414. Examples of an EM radiation concentrator 1412 include, but are not limited to, one or more lenses (e.g., Fresnel lens, biconvex, negative meniscus, simple lenses, complex lenses), a parabolic trough, black paint, one or more disks, an array of multiple elements (e.g., lenses, disks), or any suitable combination thereof. The EM radiation concentrator 1412 may be used to increase the rate at which the EM radiation is absorbed by the complex.

In one or more embodiments of the invention, the target fluid processing system 1420 of the fluid purification system 1400 is configured to transform (i.e., convert) a target fluid within a mixture into a target vapor. Specifically, the heat exchanger 1426 and/or the heating fluid source 1422 of the target fluid processing system 1420 may include the complex used to heat the target fluid. As for the heating fluid source 1422, the heating fluid source 1422 may include a vessel (e.g., a length of pipe, a cylindrical container) that includes the complex. The heating fluid source 1422 may be a pass-through system or a closed-loop system. With a pass-through system, the heating fluid is not reused for heating the target fluid. With a closed-loop system, the heating fluid is reused for heating the target fluid.

The heated fluid source 1422 may include exhaust (e.g., flue gas) from a fossil fuel burned in a boiler or any other industrial process that creates vapor that is merely released or vented into air. The concept of recapturing heated waste gas, whether produced from the same or a different process, is known to those skilled in the art. The heating fluid may have a higher boiling point than the target fluid so that the heating fluid remains a fluid before, during, and after the heat exchanger 1426 without the use of additional equipment (e.g., condenser).

The vessel of the heating fluid source 1422 may include a liquid solution (or some other material, liquid or otherwise, such as ethylene glycol or glycine) that includes the complex, be coated on one or more inside surfaces with a coating of the complex, be coated on one or more outside surfaces with a coating of the complex, include a porous matrix into which the complex is embedded, include a packed column that includes packed, therein, a substrate on which the complex is attached, include rods or similar objects coated with the complex and submerged in the fluid and/or liquid solution, be constructed of a material that includes the complex, or any combination thereof. The vessel of the heating fluid source 1422 may also be adapted to facilitate one or more EM radiation concentrators (not shown), as described above.

The vessel of the heating fluid source 1422 may be of any size, material, shape, color, degree of translucence/transparency, or any other characteristic suitable for the operating temperatures and pressures to produce the amount and type of vapor required to transform the target fluid into a target vapor. For example, the vessel of the heating fluid source 1422 may be a large, stainless steel cylindrical tank holding a quantity of solution that includes the complex and with a number of lenses (acting as EM radiation concentrators) along the lid and upper walls. In such a case, the solution may include the mixture with the target fluid to be transformed into a target vapor. Further, in such a case, the fluid includes properties such that the complex remains in the solution when a filtering system (described below) is used. Alternatively, the vessel of the heating fluid source 1422 may be a translucent pipe with the interior surfaces coated with a substrate of the complex, where the pipe is positioned at the focal point of a parabolic trough (acting as an EM radiation concentrator) made of reflective metal.

Optionally, in one or more embodiments of the invention, the vessel of the heating fluid source 1422 includes one or more temperature gauges (not shown) to measure a temperature at different points inside the vessel of the heating fluid source 1422. For example, a temperature gauge may be placed at the point in the vessel of the heating fluid source 1422 where the target vapor exits the vessel of the heating fluid source 1422. Such temperature gauge may be operatively connected to a control system (not shown) used to control the amount and/or quality of target vapor produced in purifying the target fluid. In one or more embodiments of the invention, the vessel of the heating fluid source 1422 may be pressurized where the pressure is read and/or controlled using a pressure gauge (not shown). Those skilled in the art will appreciate one or more control systems used to create target vapor in purifying the target fluid may involve a number of devices, including but not limited to the temperature gauge(s), pressure gauges, pumps (e.g., pump 1428), fans, and valves, controlled (manually and/or automatically) according to a number of protocols and operating procedures.

Optionally, in one or more embodiments of the invention, the vessel of the heating fluid source 1422 and/or the target fluid source 1424 (described below) may also include a filtering system (not shown) located inside the vessel of the heating fluid source 1422 and/or at some point before the second chamber of the heat exchanger 1426 to capture impurities (e.g., dirt, large bacteria, corrosive material) in the mixture that are not converted to the target vapor. The filtering system may vary, depending on a number of factors, including but not limited to the configuration of the vessel of the heating fluid source 1422, the configuration of the target fluid source 1424, the configuration of the heat exchanger 1426, and the purity requirements of the target fluid. The filtering system may be integrated with a control system. For example, the filtering system may operate within a temperature range measured by one or more temperature gauges.

As mentioned above, the heat exchanger 1426 may include a complex (or complexes). The heat exchanger 1426 may have two separate chambers that are adjacent to each other and allow the transfer of energy (e.g., heat) from a compound (e.g., heating fluid) flowing through one of the chambers to a different compound (e.g., target fluid) flowing through the other chamber. In the heat exchanger 1426, the two compounds are separated by a solid wall so that the two compounds do not mix. In this case, the solid wall separating the two chambers may include a complex. For example, the solid wall may be made of a material in which the complex is integrated. Alternatively, a layer of complex may be adhered to the side of the solid that is exposed to the chamber in which the heating fluid flows.

In one embodiment of the invention, the solid wall separating the two chambers is designed to maximize the transfer of heat generated by the complex. For efficiency, the heat exchanger 1426 may be designed to maximize the surface area of the solid wall between the two compounds, while minimizing resistance to the flow of the compounds through both chambers of the heat exchanger 1426. The performance of the heat exchanger 1426 may also be affected by the addition of fins or corrugations on one or both sides of the solid wall separating the chambers. The addition of fins or corrugations on one or both sides of the solid wall may increase surface area and/or channel flow of a compound to induce turbulence. A type of heat exchanger 1426 may be a plate heat exchanger, which is composed of multiple, thin, slightly-separated plates that have very large surface areas and flow passages in both chambers for heat transfer. Those skilled in the art will appreciate that the heat exchanger 1426 may be any other type of heat exchanger, now known or to be discovered, adapted to transfer energy from one chamber to another using two compounds. For example, the heat exchanger 1426 may transfer heat from the heating fluid to the complex, and then heat is again transferred from the complex to the target fluid sent by the target fluid source 1424 (described below).

In one or more embodiments of the invention, the target fluid source 1424 contains a mixture of the target fluid and other elements (e.g., impurities). The target fluid source 1424 may be any type of source, including but not limited to a pond, a stream, a storage tank, and an output of a chemical process. The mixture containing the target fluid may be any type of fluid. Examples of a mixture include, but are not limited to, brackish water, salt water, and water with bacteria, parasites, and other organisms. The mixture may include elements that have a different boiling point than the target fluid, such that the target vapor and a mixture of other vapors and/or fluids exit the heat exchanger 1426.

Optionally, in one or more embodiments of the invention, one or more pumps 1428 may be used in the target fluid processing system 1420. A pump 1428 may be used to regulate the flow of the heating fluid in the heating fluid source 1422 and/or the target fluid in the target fluid source 1424. A pump 1428 may operate manually or automatically (as with a control system, described above). Each pump 1428 may operate using a variable speed motor or a fixed speed motor. The flow of heating fluid and/or target fluid may also be controlled by gravity, pressure differential, some other suitable mechanism, or any combination thereof.

In one or more embodiments of the invention, the fluid purification system 1430 is used to extract the target vapor from the rest of the mixture and condense the target vapor to the target fluid. The pressurized vessel 1432 of the fluid purification system 1430 may receive the target vapor as well as the rest of the mixture (whether in vapor and/or fluid form). The pressurized vessel 1432 may operate at one or more of a number of pressures. The pressure of the pressurized vessel 1432 may be determined and/or adjusted manually (as by an operator) or automatically (as part of a control system). The pressure of the pressurized vessel 1432 may be used to separate the target vapor from the rest of the mixture. The pressurized vessel 1432 may send the target vapor to the condenser 1434.

In one or more embodiments of the invention, the waste retrieval system 1436 of the fluid purification system 1430 removes the elements of the mixture (i.e., the impurities) that remain after the pressurized vessel 1432 separates the target vapor from the mixture. The waste retrieval system 1436 may be coupled to the pressurized vessel 1432. For example, the waste retrieval system 1436 may extract fluid impurities from the bottom of the pressurized vessel 1432 using, for example, a drain. Also, the waste retrieval system 1436 may extract vapor impurities from the top of the pressurized vessel 1432 using, for example, a vent that is capable of extracting only the impurities and not the target vapor.

In one or more embodiments of the invention, the condenser 1434 of the fluid purification system 1430 is configured to condense the target vapor received from the pressurized vessel 1432 to the target fluid. The condenser 1434 may use air, water, or any other suitable material/medium to cool the target vapor. The condenser 1434 may also operate under a particular pressure, such as under a vacuum. Those skilled in the art will appreciate that the condenser 1434 may be any type of condenser, now known or to be discovered, adapted to liquefy a vapor.

Optionally, in one or more embodiments of the invention, the storage tank 1438 of the fluid purification system 1430 is configured to store the target fluid after the target fluid has been condensed by the condenser 1434.

FIG. 15 shows a flowchart for a method for purifying a fluid in accordance with one or more embodiments of the invention. While the various steps in this flowchart are presented and described sequentially, one of ordinary skill will appreciate that some or all of the steps may be executed in different orders, may be combined or omitted, and some or all of the steps may be executed in parallel. Further, in one or more of the embodiments of the invention, one or more of the steps described below may be omitted, repeated, and/or performed in a different order. In addition, a person of ordinary skill in the art will appreciate that additional steps, omitted in FIG. 15, may be included in performing this method. Accordingly, the specific arrangement of steps shown in FIG. 15 should not be construed as limiting the scope of the invention.

Referring to FIG. 15, in Step 1502, a heating fluid is sent to a heating fluid vessel. In one or more embodiments of the invention, the heating fluid includes a complex. The heating fluid may be any liquid. In embodiments of the invention, the heating fluid has a higher boiling point than the boiling point of the target fluid (described below). The heating fluid vessel may be any container capable of holding a volume of the heating fluid. For example, the heating fluid vessel may be a pipe, a chamber, or some other suitable container. In one or more embodiments of the invention, the heating fluid vessel is adapted to maintain its characteristics (e.g., form, properties) under high temperatures for extended periods of time. The complex may be part of a solution inside the heating fluid vessel, a coating on the outside of the heating fluid vessel, a coating on the inside of the heating fluid vessel, integrated as part of the material of which the heating fluid vessel is made, integrated with the heating fluid vessel in some other way, or any suitable combination thereof. The heating fluid may be received in the heating fluid vessel using gravity, pressure differential, a pump, a valve, a regulator, some other device to control the flow of the heating fluid, or any suitable combination thereof.

Optionally, in Step 1504, EM radiation sent by an EM radiation source (described above with respect to FIG. 14) to the vessel is concentrated. In one or more embodiments of the invention, the EM radiation is concentrated using an EM radiation concentrator, as described above with respect to FIG. 14. For example, the EM radiation may be concentrated using one or more lenses or a parabolic trough. In one or more embodiments of the invention, the EM radiation is concentrated merely by exposing the vessel to the EM radiation.

In Step 1506, the EM radiation is applied to the complex. In one or more embodiments of the invention, the complex absorbs the EM radiation to generate heat. The EM radiation may be applied to all or a portion of the complex contained in the heating fluid vessel. The EM radiation may also be applied to an intermediary, which in turn applies the EM radiation (either directly or indirectly, as through convection) to the complex. A control system using, for example, one or more temperature gauges, may regulate the amount of EM radiation applied to the complex, thus controlling the amount of heat generated by the complex at a given point in time. Power required for any component in the control system may be supplied by any of a number of external sources (e.g., a battery, a photovoltaic solar array, alternating current power, direct current power).

In Step 1508, heating fluid is sent through the first chamber of a heat exchanger. In one or more embodiments of the invention, the heating fluid includes the complex. The heat exchanger may be substantially similar to the heat exchanger described above with respect to FIG. 14.

In Step 1510, a mixture is sent through a second chamber of the heat exchanger. In one or more embodiments of the invention, the mixture includes a target fluid, which is the fluid to be purified. The target fluid may have a lower boiling point than the boiling point of some or all of the other elements in the mixture, as well as the boiling point of the heating fluid. The mixture may be sent through the second chamber of the heat exchanger while the heating fluid flows through the first chamber of the heat exchanger. In embodiments of the invention, the target fluid in the mixture is transformed to a target vapor. Specifically, the heat generated by the complex may be used to heat the mixture to any temperature at or beyond the boiling point of the target fluid.

In Step 1512, the target vapor and the remainder of the mixture are sent from the heat exchanger to a pressurized vessel. Some or all of the remainder of the elements in the mixture may be in vapor, fluid and/or solid form. The target vapor and the remainder of the mixture may be sent to the pressurized vessel using gravity, pressure differential, a pump, a fan, some other suitable mechanism, or any combination thereof. In embodiments of the invention, the pressurized vessel may not be used, in which case the process proceeds to Step 1516, where the target vapor is sent to the condenser.

In Step 1514, the target vapor is extracted from the remainder of the mixture in the pressurized vessel. In one or more embodiments of the invention, the pressurized vessel is configured in such a way as to separate the target vapor from the remainder of the mixture. For example, the pressurized vessel may include a mixer, a centrifuge, a filtering system (such as the filtering system described above with respect to, for example, the target fluid source 1424), some other suitable filtering mechanism, or any combination thereof. The pressurized vessel may include a waste disposal system used to remove the remainder of the mixture for disposal and/or use in a separate process.

In Step 1516, the target vapor is sent from the pressurized vessel to a condenser. The target vapor may be sent to the pressurized vessel using gravity, pressure differential, a pump, a fan, some other suitable mechanism, or any combination thereof.

In Step 1518, the target vapor is condensed to the target fluid in the condenser. The condenser may use air, water, or any other suitable material/medium to cool the target vapor. The condenser may also operate under a particular pressure, such as under a vacuum. In Step 1520, the target fluid is extracted from the condenser. In one or more embodiments of the invention, the target fluid is purified, either completely or meeting some minimal standard of purification (e.g., 99.5% pure). After completing Step 1520, the process ends.

### Example

### Fluid Purification System Using a Heat Exchanger

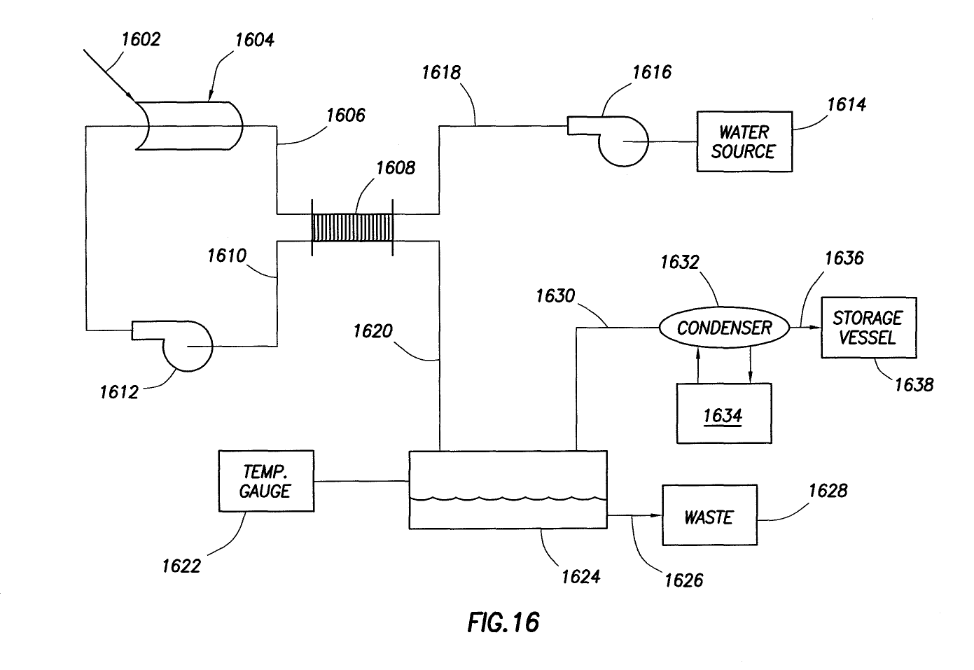

Consider the following example, shown in FIG. 16, which describes a process for purifying a fluid using a heat exchanger in accordance with one or more embodiments described above. In this example, the heating fluid is circulated through one chamber of the heat exchanger 1608 in a closed-loop system (i.e., the heating fluid source). Specifically, a pump 1612 is used to circulate the heating fluid (which may or may not include a complex) through a section of pipe 1602 coated with a complex (i.e., the heating fluid vessel), then through pipe 1606 not coated with complex, through the first chamber of the heat exchanger 1608, and through more pipe 1610 to return to the pump 1612.

In cases where the heating fluid vessel is a pipe, as shown in FIG. 16 above, the complex may be incorporated into the heating fluid vessel in one of a number of ways. For example, the complex may be applied to the inside surface of the pipe. In this case, the complex may not be applied evenly (i.e., non-uniformly), so that a greater amount of surface area of the complex may come in direct contact with the fluid as the fluid flows through the pipe. The greater amount of surface area may allow for a greater transfer of heat from the pipe to the heating fluid. The complex may also be applied evenly (i.e., uniformly) to the inside surface of the pipe. Alternatively, the complex may be applied to the outer surface of the pipe as an even coating. Those skilled in the art will appreciate that integrating the complex with the pipe (or any other form of heating fluid vessel) may occur in any of a number of other ways.

The heating fluid source may also include a concentrator 1604. In this example, the concentrator 1604 is a parabolic trough that encompasses the section of pipe 1602 coated with the complex and is positioned in such a manner as to concentrate EM radiation received from an EM radiation source (not shown) on the pipe 1602 coated with the complex. Further, in this example, the heating fluid is ethylene glycol, which is heated from the heat emitted from the complex in the pipe 1602 coated with the complex as the heating fluid circulates through that section of the heating fluid source.

Further, in this example, a mixture is extracted from a water source 1614, which may generally be any source of a mixture containing a fluid, and sent to a second chamber of the heat exchanger 1608 through piping 1618 using a pump 1616. In embodiments of the invention, a filtering system (not shown) may be integrated with the piping 1618 to remove certain impurities (e.g., solids, large bacteria) from the mixture. Similar filtering systems may also be used in other portions of this system.

As the mixture passes through the second chamber of the heat exchanger 1608, the heat of the heating fluid passing through the first chamber of the heat exchanger 1608 is transferred to the mixture. The heat transferred to the mixture in the heat exchanger 1608 raises the temperature of the mixture to a point beyond the boiling point of the target fluid. As a result, the target fluid vaporizes into target vapor while at least some of the rest of the mixture (i.e., the remainder of the mixture) remains in fluid form.

The target fluid and the remainder of the mixture is then sent through piping 1620 to a pressurized vessel 1624. The pressurized vessel 1624 also includes a temperature gauge 1622, which may be integrated with a control system (not shown) along with other devices, including but not limited to a pressure gauge. The remainder of the mixture delivered to the pressurized vessel 1624 pools at the bottom portion of the pressurized vessel 1624, while the target vapor rises to the top portion of the pressurized vessel 1624. The remainder of the mixture is extracted from the pressurized vessel 1624 through piping 1626 as waste 1628.

The target vapor is collected and sent to a condenser 1632 through piping 1630, where the target vapor is condensed to the target fluid. In this example, the condenser 1632 uses a source 1634, such as air, to condense the target vapor. The target fluid is then removed from the condenser 1632 through piping 1636 to a storage vessel 1638.

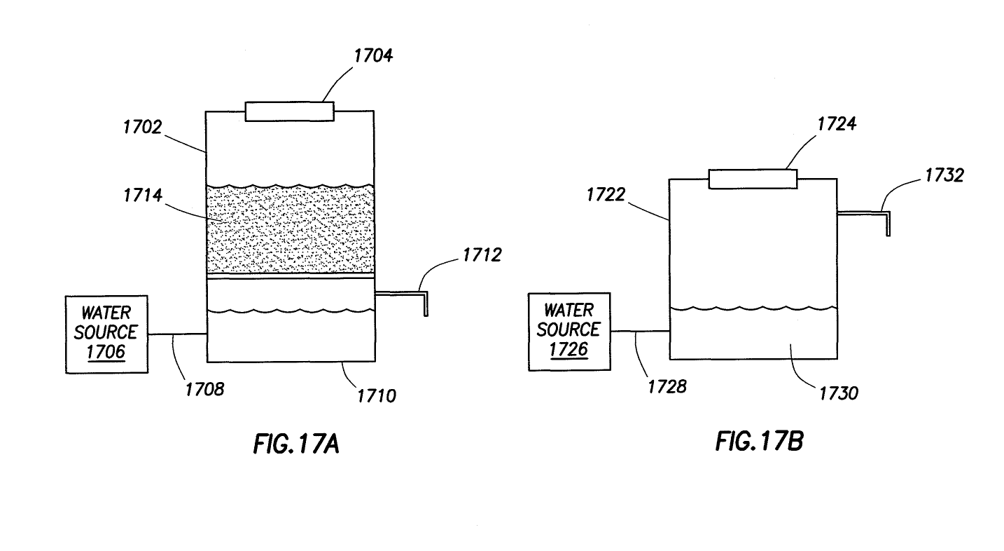

As discussed above, the process of heating the target fluid in the mixture to the target vapor may occur in a number of ways without using a heat exchanger. Specifically, the heating fluid vessel may take any of a number of forms. Further examples of various heating fluid vessels are shown in FIGS. 17A and 17B. In FIG. 17A, a heating fluid vessel in the form of two separate compartments that abut against each other is shown. The top compartment 1702 (i.e., the heating fluid vessel) contains a heating fluid mixed with a complex 1714. The top compartment 1702 also includes a concentrator 1704. In this example, the concentrator 1704 is a lens located at the top end of the top compartment 1702. As EM radiation emitted from an EM radiation source (not shown) is concentrated by the concentrator 1704 and contacts the heating fluid, the complex absorbs the EM radiation and generates heat.

The bottom compartment 1710 shown in FIG. 17A receives the mixture through piping 1708 from a water source 1706, which may be a source of any mixture that includes the target fluid. The heat emitted from the heating fluid 1714 in the top compartment 1702 is radiated through the bottom of the top compartment 1702 to the top of the bottom compartment 1710. This radiated heat heats the mixture in the bottom compartment 1710 to a temperature above the boiling point of the target fluid, transforming the target fluid to the target vapor. The target vapor is then moved from the bottom compartment 1710 to a pressurized vessel and/or a condenser (for example via pipe 1712), as described above with respect to FIG. 16. In embodiments of the invention, the top compartment 1702 and the bottom compartment 1710 may be detachable, as for a portable fluid purification device.

Another example of a heating fluid vessel is shown in FIG. 17B. Specifically, the heating fluid vessel 1722 includes a complex. The complex may be coated on one or more inner surfaces of the heating fluid vessel 1722, floating in the mixture 1730 in the heating fluid vessel 1722, incorporated in some other matter with the heating fluid vessel 1722, or any combination thereof. The heating fluid vessel 1722 receives the mixture through piping 1728 from a water source 1726, which may be a source of any mixture that includes the target fluid.

The heating fluid vessel 1722 also includes a concentrator 1724. In this example, the concentrator 1724 is a lens located at the top end of the heating fluid vessel 1722. As EM radiation emitted from an EM radiation source (not shown) is concentrated by the concentrator 1724 and contacts the complex, the complex absorbs the EM radiation and generates heat. The heat generated by the complex radiates to the mixture inside the heating fluid vessel 1722 and heats the mixture to a temperature above the boiling point of the target fluid, transforming the target fluid to the target vapor. The target vapor is then moved from the heating fluid vessel 1722 to a pressurized vessel and/or a condenser (for example via pipe 1712), as described above with respect to FIG. 16.

One or more embodiments of the invention purify a target fluid extracted from a mixture that includes one or more impurities. The amount of target fluid that is purified by embodiments of the invention may range from a few ounces of target fluid to thousands of gallons (or more) of target fluid. Embodiments of the invention may be portable, allowing for mobile and temporary applications. For example, embodiments of the invention may be used by relief workers to supply portable water to areas struck by a natural disaster, areas where a water treatment plant has been disabled, or some other similar location needing portable water. Embodiments of the invention may also be used in underdeveloped areas where no sources of portable water exist. Embodiments of the invention may also be used to purify some other compound or chemical, including but not limited to oil, gasoline, an acid, and an alcohol.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method to purify a fluid, the method comprising:
sending a first fluid comprising a complex through a heating fluid vessel, wherein the complex is at least one selected from a group consisting of copper nanoparticles, copper oxide nanoparticles, nanoshells, nanorods, carbon moieties, encapsulated nanoshells, encapsulated nanoparticles, and branched nanostructures;
applying, while the first fluid is in the heating fluid vessel, electromagnetic (EM) radiation to the complex, wherein the complex absorbs the EM radiation to generate heat and wherein the heat increases a temperature of the first fluid to generate a first heated fluid;
sending the first heated fluid through a first chamber of a heat exchanger;
sending, while the first heated fluid flows through the first chamber of the heat exchanger, a mixture into a second chamber of the heat exchanger, wherein the mixture comprises a second fluid;
transforming, using the heat generated by the complex in the first heated fluid, at least a portion of the second fluid of the mixture to a target vapor;
sending the target vapor from the second chamber of the heat exchanger to a condenser;
condensing, in the condenser, the target vapor to obtain a purified fluid; and
extracting the purified fluid from the condenser.

2. The method of claim 1, further comprising:
retrieving the first heated fluid from the first chamber of the heat exchanger; and
sending the first heated fluid through the heating fluid vessel.

3. The method of claim 1, further comprising:
concentrating the EM radiation, prior to applying the EM radiation to the heating fluid vessel using a concentrator.

4. The method of claim 3, wherein the heating fluid vessel is a pipe and wherein the concentrator is a parabolic trough.

5. The method of claim 3, wherein the heating fluid vessel is a cylinder and wherein the concentrator is a lens integrated with a surface of the cylinder.

6. The method of claim 1, further comprising:
controlling, using a pump, a temperature gauge, and a pressure gauge, a first amount of the first fluid and a second amount of the mixture flowing through the heat exchanger.

7. The method of claim 1, wherein the target fluid is water and the target vapor is steam.

8. The method of claim 1, wherein the first fluid is ethylene glycol.

9. A system, comprising:
a heating fluid vessel comprising first fluid and a complex, wherein the complex receives electromagnetic (EM) radiation, wherein the complex absorbs the EM radiation to generate heat and wherein the heat increases a temperature of the first fluid to generate a first heated fluid;
a heat exchanger adapted to:
receive the first heated fluid in a first chamber;
receive a mixture comprising a second fluid in a second chamber; and
transfer heat from the first fluid to the mixture to transform at least a portion of the second fluid of the mixture to a target vapor; and
a condenser adapted to:
receive the target vapor; and
condense the target vapor to generate target fluid.

10. The system of claim 9, further comprising:
a control system adapted to control a first amount of the first fluid and a second amount of the mixture through the heat exchanger, wherein the control system comprises a pump, a temperature gauge, and a pressure gauge.

11. The system of claim 10, wherein the pump is used to circulate the first fluid between the heating fluid vessel and the heat exchanger.

12. The system of claim 9, further comprising:
a waste retrieval system used to collect impurities removed from the mixture.

13. The system of claim 9, wherein the mixture is untreated.

14. The system of claim 9, wherein the complex is suspended in the first fluid.

15. The system of claim 9, wherein the complex is at least one selected from a group consisting of copper nanoparticles, copper oxide nanoparticles, nanoshells, nanorods, carbon moieties, encapsulated nanoshells, encapsulated nanoparticles, and branched nanostructures.
